(19) United States
(12) Patent Application Publication
(10) Pub. No.: US 2025/0110764 A1
(43) Pub. Date: Apr. 3, 2025

(54) POLICY DEPLOYMENT AND AUTOMATION IN A CLOUD-COMPUTING ENVIRONMENT

(71) Applicant: Insight Direct USA, Inc., Chandler, AZ (US)

(72) Inventor: David Bruce Epperson, II, Altamonte Springs, FL (US)

(21) Appl. No.: 18/374,111

(22) Filed: Sep. 28, 2023

(51) Int. Cl. G06F 9/455

(52) U.S. Cl. CPC G06F 9/45558; G06F 2009/4557

(57) ABSTRACT

Instances of an identity and access management (IAM) system access resources through a cloud platform. An association module executed on control circuitry of a computing device is configured to determine a resident location of a base instance of the IAM system, obtain manager identity data for a manager instance of the IAM system associated with the resident location, and edit access settings for one or more containers within the base instance to provide access to the manager instance. The manager instance can access the one or more containers to service the resources within the one or more containers.

### BACKGROUND

This disclosure relates generally to authorizing users. More specifically, this disclosure relates to automated locational identification for a managed identity and synchronization between the managed identity and a manager identity.

A cloud computing platform includes an identity and access management (IAM) system that controls access to resources through the cloud platform. A unique identifier is assigned to each dedicated and trusted instance of an IAM system on the cloud computing platform. The unique identifier is associated with one or more logical containers into which resources and services can be created, configurated, installed, etc. The logical containers can be utilized to control access to resources, allocation of resources, etc.

The owner of a base instance of the IAM system can designate one or more other instances of the IAM system, each having its own unique identifier, as an authorized user of one or more resources within the base instance. Designating the other instance as an authorized user provides that other instance access to the base instance to provide a variety of services (e.g., infrastructure management, database management, security management, application management, etc. Infrastructure management can include virtual machine (VM) and network management, while database management can include SQL and NoSQL databases. Security management services offer threat detection and response, compliance management, and identity and access management. Application management services include application migration, deployment, and monitoring.).

The scope of the services available can vary regionally basis, such as on a country-by-country basis. Products and features on the cloud computing platform may be available only in certain regions. A single services provider can be the owner of multiple instances of the IAM system that are each associated with various home geographical areas to provide services to resources available within those areas. Identifying and designating the appropriate instance to manage a base instance can be a laborious and time-consuming process.

### SUMMARY

According to an aspect of the present disclosure, a method of associating users in a cloud computing space includes determining, by an association module executed by control circuitry of a computing device, a resident location associated with a base instance of an identity and access management system of the cloud computing space; obtaining, by the association module, manager identity data from an identification module of the association module based on the resident location, the manager identity data uniquely identifying a manager instance of the identity and access management system; editing, by the association module, access settings for a first container of the base instance such that the manager instance is authorized to access the first container and one or more resources grouped within the first container; and accessing, by the manager instance, the first container of the base instance.

According to an additional or alternative aspect of the present disclosure, a system for associating users in a cloud computing space includes a computing device having a memory and control circuitry configured to execute instructions stored in the memory; and a remote computing device configured to transmit an association module to the computing device. The control circuity is configured to execute the association module to cause the association module to: determine a resident location associated with a base instance of an identity and access management system of the cloud computing space; obtain manager identity data from an identification module of the association module based on the resident location, the manager identity data identifying a manager instance of the identity and access management system; and edit access settings for a first container of the base instance, such that the manager instance is authorized to access the first container and one or more resources grouped within the first container.

According to another additional or alternative aspect of the present disclosure, a method of associating users in a cloud computing space includes determining, by an association module executed by control circuitry of a computing device, a resident location associated with a base instance of an identity and access management system of the cloud computing space; comparing, by the association module, the resident location to a plurality of manager identity locations stored in an identification module of the association module to identify a manager identity location of the plurality of manager identity locations as a location match with the resident location; obtaining, by the association module, manager identity data associated with the manager identity location of the plurality of manager identity locations, the manager identity data uniquely identifying a manager instance of the identity and access management system; identifying, by the association module, a candidate container from within the base instance; editing, by the association module, access settings of the candidate container such that the manager instance is authorized to access the candidate container; and one or more resources grouped within the candidate container; and accessing, via the manager instance, the candidate container.

### BRIEF DESCRIPTION OF THE DRAWINGS

FIG. 1 is a block diagram illustrating a cloud computing system.

FIG. 2 is a block diagram illustrating an access hierarchy within an instance of an identity and access management system of a cloud computing system.

FIG. 3 is a flowchart illustrating an example of a method of associating users in a cloud computing space.

### DETAILED DESCRIPTION

The present disclosure relates to methods and systems for authorizing access to and management of resources within a cloud computing space. Instances of an identity and access management (IAM) system that control access to resources on the cloud computing network are associated such that one of the instances (a “manager instance” can access resources within the other instance (a “base instance”) to service resources grouped within the base instance. The cloud computing system can be divided geographically, such as to allocate resources according to governmental regulation and provide deployment locations associated with locations of owners of the instances of the IAM system. The availability of products and features on the cloud computing platform can vary geographically. The geographic location of a base instance is required to associate the correct manager instance with that base instance to allow a managed services provider (MSP) to provide services for the base instance (e.g., infrastructure management, database management, security management, application management, etc.). Such services can include virtual machine (VM) and network management, SQL and NoSQL databases, threat detection and response, compliance management, identity and access management, application migration, application deployment, application monitoring, among others.

According to aspects of the present disclosure, an association module is executed by control circuitry to determine a resident geographic location associated with a base instance of an IAM system. The association module is further configured to identify a manager instance associated with that resident geographic location. The association module can be configured to edit access settings for the base instance to provide the manager instance access to resources within the base instance to provide services to those resources.

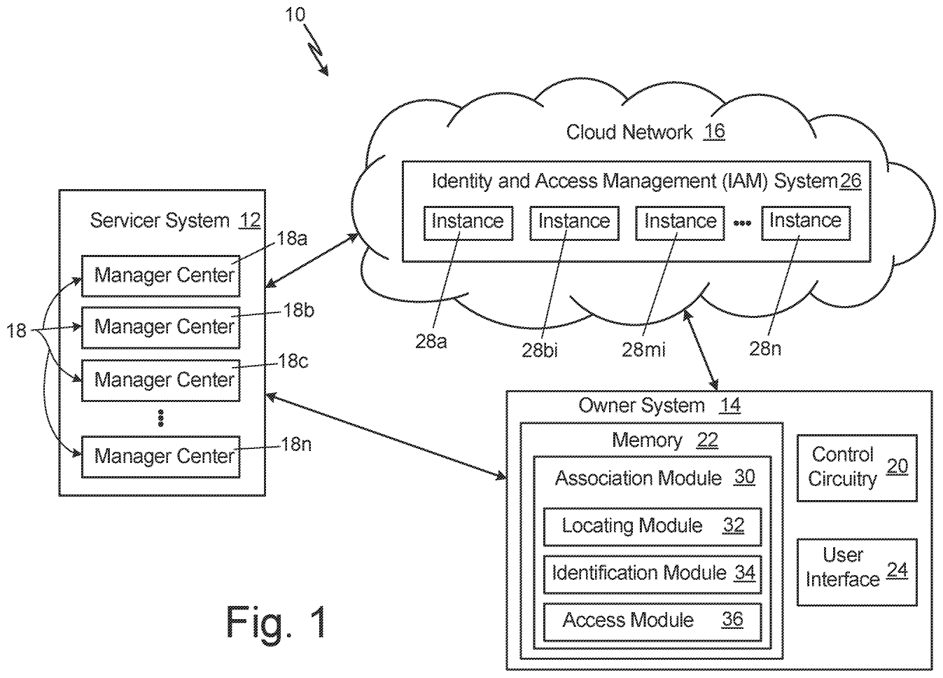

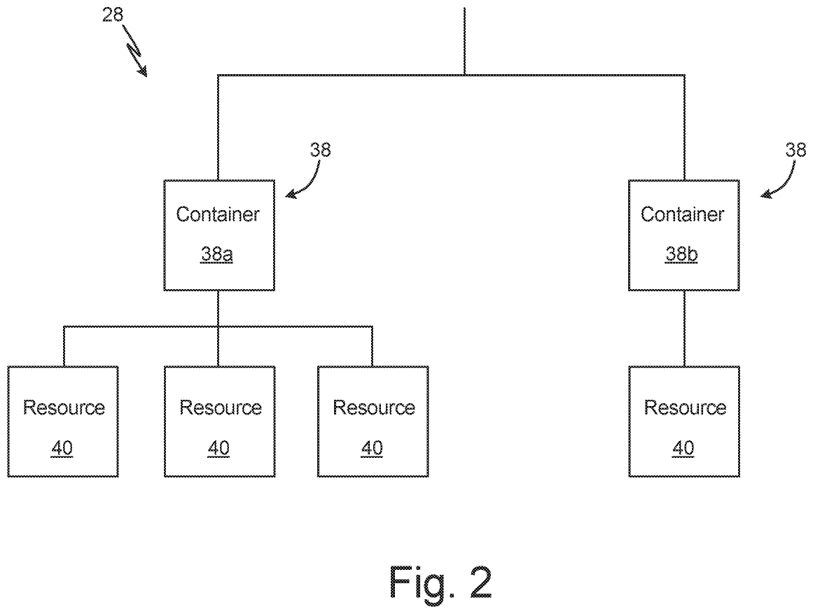

FIG. 1 is a schematic block diagram illustrating cloud computing system 10. FIG. 2 is a block diagram illustrating an access hierarchy within an instance 28 of identity and access management (IAM) system 26 of cloud computing network 16. FIGS. 1 and 2 are discussed together.

Cloud computing system 10 includes servicer system 12, owner system 14, and cloud network 16. Servicer system 12 includes manager centers 18a-18n (collectively herein “manager center 18” or “manager centers 18”). Owner system 14 includes control circuitry 20, memory 22, and user interface 24. Identity and access management (IAM) system 26 is disposed on cloud network 16. Instances 28a-28n (collectively herein “instance 28” or “instances 28”) of IAM system 26 are shown, which instances 28 include base instance 28bi and manager instances 28. Association module 30 is shown in FIG. 1. Association module 30 includes location module 32, identification module 34, and access module 36.

Cloud computing system 10 is configured to provide on-demand access (e.g., via the Internet) to computing resources 40 (e.g., applications, servers (physical servers and virtual servers), data storage, development tools, networking capabilities, among others). Cloud network 16 can be hosted at one or more remote data center managed by a cloud services provider (CSP). The CSP makes these resources available for usage by users of the cloud network 16. For example, the CSP can charge users a monthly subscription fee or based on usage.

Cloud network 16 hosts IAM system 26. IAM system 26 enables access to external resources (e.g., data storage, software as a service (SaaS) applications, virtual machines, etc.) and internal resources (e.g., resources on an intranet, cloud applications developed for that organization, etc.). IAM system 26 provides common identity and access capabilities. Users access resources 40 on cloud network 16 via IAM system 26. The IAM system 26 can also be referred to as a directory or name service. In some examples, IAM system 26 can be configured similar to Azure Active Directory (available from Microsoft).

Each instance 28a-28n is a single dedicated and trusted case of the IAM system 26. A universally/globally unique identifier (UUID/GUID) is assigned to each dedicated and trusted instance 28 of IAM system 26. The UUID/GUID uniquely identifies each instance 28 relative to every other instance 28 of IAM system 26. Cloud network 16 can also be considered to form a multi-tenant system in which each instance 28 is considered to form a unique tenant of the multi-tenant system.

A single instance 28 can be utilized by multiple discrete users. For example, an organization can be the owner of a single instance 28 of the IAM system 26 and multiple employees of that organization can access the cloud network 16 and resources, internal or external to the organization, grouped within that single instance 28 via that single instance 28.

As shown in FIG. 2, each instance 28 can have an internal hierarchy. In the example shown, one or more logical containers 38 are grouped within an instance 28. A container 38 provides an isolated environment for accessing resources 40 running on a server of the cloud computing system 10. The resources 40 can be distributed among the containers 38. The containers 38 can provide access control to resources 40, isolate resources 40 (e.g., between departments, projects, regions, etc.), utilize different payment methods for paying for the resources 40, etc. Resources 40 (e.g., virtual machines, web applications, storage accounts, automations, functions, logic applications, etc.) can be created, configured, and installed into containers 38. In some examples, resources 40 can be grouped within sub-groups within each logical container 38. In some examples, containers 38 can be grouped together within a master container such that multiple containers 38 are hierarchically grouped under that master container.

User access can be defined at any desired hierarchical level. For example, user access can be defined at resource-level (e.g., individually by resource 40), on a hierarchical level intermediate containers 38 and resources 40 (e.g., to provide access to a group of, but less than all, resources 40 within a container 38); on a hierarchical level above containers 38 (e.g., to provide access to multiple containers 38 simultaneously); among other hierarchical access options. For purposes of brevity, examples of container-level access are discussed in more detail herein, though it is understood that such discussion can be equally applicable for other hierarchical access structures, unless explicitly noted otherwise.

For example, a first user of an instance 28 can be provided access to resources 40 within container 38a and denied access to resources 40 in container 38b; a second user can be authorized to read, but not edit, resources 40 within container 38a and provided read/write access to resources 40 in container 38b; a third user can be authorized to edit user access to both containers 38a, 38b; a fourth user can be denied access to resources 40 in container 38a and provided full access to manage resources 40 in container 38b without being able to assign edit user access; etc. In some examples, access can be regulated by role-based access controls (RBAC) such that users are assigned various roles that define the access rights of that user. For example, a user can be designated as a “reader” to have read-only rights, a user can be designated as an “owner” to have full access rights and the ability to add/change users/roles; a user can be designated as a “manager” to have full access without the ability to add/change users/roles; etc.

Owner system 14 is configured to store software, implement functionality, and/or process instructions. Owner system 14 can be of any suitable configuration for gathering data, processing data, etc. Owner system 14 can be formed by one or more computing devices. Owner system 14 is associated with an instance 28 of the IAM system 26. The instance 28 associated with the owner system 14 can be referred to as a base instance 28bi. Owner system 14 can be configured to receive inputs and/or provide outputs via user interface 24. Owner system 14 can include hardware, firmware, and/or stored software. The owner system 14 can be entirely or partially mounted on one or more circuit boards. Owner system 14 can be considered to form a single computing device even when distributed across multiple component devices. The owner system 14 can be of any type suitable for operating in accordance with the techniques described herein. In some examples, the owner system 14 can be implemented as a plurality of discrete circuitry subassemblies.

Control circuitry 20, in one example, is configured to implement functionality and/or process instructions. For example, the control circuitry 20 can be capable of processing instructions stored in the memory 22. Examples of control circuitry 20 can include one or more of a processor, a microprocessor, a controller, a digital signal processor (DSP), an application specific integrated circuit (ASIC), a field-programmable gate array (FPGA), or other equivalent discrete or integrated logic circuitry. The control circuitry 20 can be entirely or partially mounted on one or more circuit boards.

Memory 22 can be configured to store data and information before, during, and/or after operation. Memory 22, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 22 is a temporary memory, meaning that a primary purpose of memory 22 is not long-term storage. Memory 22, in some examples, is described as volatile memory, meaning that memory 22 does not maintain stored contents when power is turned off. Examples of volatile memories can include random access memories (RAM), dynamic random access memories (DRAM), static random access memories (SRAM), and other forms of volatile memories. In some examples, the memory 22 is used to store program instructions for execution by the control circuitry 20. The memory 22, in one example, is used by association module 30 to temporarily store information during program execution.

Memory 22, in some examples, also includes one or more computer-readable storage media. Memory 22 can be configured to store larger amounts of information than volatile memory. Memory 22 can further be configured for long-term storage of information. In some examples, the memory 22 includes non-volatile storage elements. Examples of such non-volatile storage elements can include magnetic hard discs, optical discs, flash memories, or forms of electrically programmable memories (EPROM) or electrically erasable and programmable (EEPROM) memories.

User interface 24 can be configured as an input and/or output device. For example, the user interface 24 can be configured to receive inputs from a data source and/or provide outputs, such as prompts or other outputs from association module 30. Examples of user interface 24 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

Servicer system 12 is configured to store software, implement functionality, and/or process instructions. Servicer system 12 can be of any suitable configuration for gathering data, processing data, etc. Servicer system 12 can include one or more computing devices (e.g., similar to owner system 14).

In the example shown, servicer system 12 includes manager centers 18a-18n. Each manager center 18 is configured to provide a variety of services (e.g., (e.g., infrastructure management, database management, security management, application management, etc.) to multiple instances 28 on cloud network 16. Each manager center 18 can additionally or alternatively be referred to as a “policy center” or “servicer data center”. Each manager center 18 can be configured as one or more computing devices having control circuity (similar to control circuitry 20), memory (similar to memory 22), and in some examples user interface (similar to user interface 24). Servicer system 12 can include computing devices other than manager centers 18, such as to transmit association module 30 to owner system 14 for execution of association module 30 on owner system 14.

Association module 30 is shown as stored on memory 22 of owner system 14 in FIG. 1. Association module 30 is configured to associate a manager center 18 with the base instance 28bi associated with owner system 14 such that the manager center 18 can access and provide services to resources 40 accessible through the base instance 28bi. Association module 30 is configured to perform any of the functions attributed herein to association module 30. Association module 30 can take the form of computer-readable instructions that, when executed by control circuitry 20, cause implementation of functionality attributed herein to association module 30. In some examples, association module 30 can include and/or be implemented as downloadable software in the form of a mobile application. The mobile application can be implemented on a computing device, such as a personal computer, tablet, or smartphone, among other suitable devices.

In the example shown, association module 30 includes sub-modules 32, 34, 36. The sub-modules include location module 32, identification module 34, and access module 36. Module 30 and one or more of sub-modules 32, 34, 36 can take the form of computer-readable instructions that, when executed by control circuitry (e.g., control circuitry 20), cause implementation of functionality attributed herein to module 30 and one or more of sub-modules 32, 34, 36. The techniques described herein with respect to module 30 can be implemented by a single module or multiple modules (e.g. two, three, four, etc.) that distribute functionality attributed herein to module 30 among the multiple modules. Further, while the example of FIG. 1 is described with respect to separate sub-modules 32, 34, 36 forming association module 30, it is understood that the techniques described herein with respect to such sub-modules 32, 34, 36 can be implemented by a single module or multiple modules (e.g. two, three, four, etc.) that distribute functionality attributed herein to modules 32, 34, 36 among the multiple modules.

In general, memory 22 can store association module 30 in the form of computer-readable instructions that, when executed by control circuitry 20, cause association module 30 to operate in accordance with techniques described herein. In operation, the owner system 14 executes the association module 30 to associate a manager center 18 with base instance 28bi such that the manager center 18 can provide services to resources 40 accessible through the base instance 28bi.

The scope of the services and resources available on cloud network 16 can vary regionally. The cloud network 16 can be divided geographically, such as to allocate resources according to governmental regulation and provide deployment locations associated with the locations of instance owners. In some cases, the scope of services and resources that are available vary on a country-by-country basis. Each manager center 18 is associated with a discrete region to provide services available in that region for resources 40 available in that region. For example, a first manager center 18a can be configured to provide services in the United States, a second manager center 18b can be configured to provide services in Canada, a third manager center 18c can be configured to provide services in Australia, etc. The first manager center 18 can be associated only with owners in the United States, while the second manager center 18 can be associated only with owners in Canada, etc. Each manager center 18 has an associated manager instance 28mi of the IAM system 26. The manager instance 28mi for each manager center 18a-18n is unique relative to the manager instances 28mi for the other manager centers 18a-18n.

A manager center 18 is provided access to the base instance 28bi associated with owner system 14 such that the manager center 18 can service resources 40 within base instance 28bi. Association module 30 is configured to determine the region associated with the base instance 28bi and identify a manager center 18 configured to provide services in the determined region, such a manager center 18 can be referred to as the “identified manager center 18.” Association module 30 can be further configured to edit access settings within the base instance 28bi to provide the identified manager center 18 with access to one or more of the resources 40 accessible through the base instance 28bi. The association module 30 can edit the access settings such that the manager instance 28mi is provided access to the resources 40 within the base instance 28bi. In some examples, the association module 30 is configured to edit access settings for one or more containers 38 to provide the identified manager center 18 access to the resources 40 disposed within the edited containers 38. In some examples, association module 30 is configured to edit access settings for one or more resources 40 to provide the identified manager center 18 access to those resources 40. As discussed above, the association module 30 can be configured to edit access settings at any desired hierarchical level within base instance 28bi.

The association module 30 can be transmitted to the owner system 14 from servicer system 12. One or more computing devices of the servicer system 12 can be considered to form a remote computing device that provides the association module 30 to the owner system 14 for execution by control circuitry 20 of owner system 14. In some examples, the servicer system 12 is configured to transmit the association module 30 based on a request from the owner system 14. Servicer system 12 can transmit association module 30 to owner system 14 utilizing communication outside of cloud network 16. For example, servicer system 12 can transmit the association module 30 to owner system 14 via the Internet.

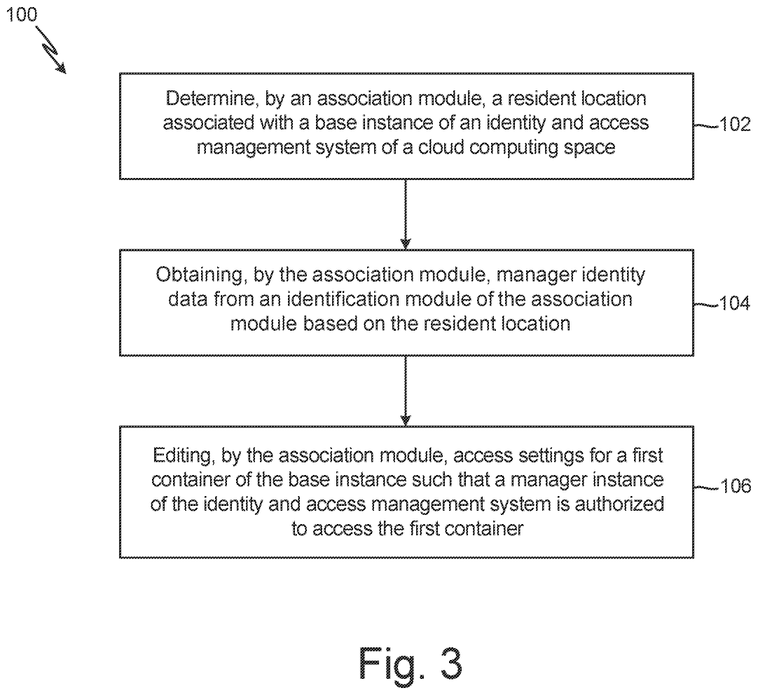

A flowchart illustrating an example method 100 of associating users within cloud network 16 is shown in FIG. 3, which is discussed with continued reference to FIGS. 1 and 2. During operation, association module 30 is executed by control circuitry 20 of owner system 14. For example, a user having rights to edit user access settings within base instance 28bi can access the base instance 28bi and cause the association module 30 to be executed. In some examples, the user can cause control circuitry 20 to execute association module 30 while the user is logged in to the base instance 28bi. For example, a user authorized to edit access settings of the base instance 28bi can execute the association module 30 while logged in such that the association module 30 can also edit the access settings.

In some examples, association module 30 can be configured to provide different access levels (e.g., full rights, support only, read only, etc.) to a manager instance 28mi. In some examples, a user can indicate the desired access level to be provided to the manager instance 28mi on initial execution of association module 30 by control circuitry 20. In some examples, association module 30 can be configured to provide a first access level unless indicated otherwise by a user, in which case the association module 30 can provide a second access level different from the first access level based on the user input. In some examples, association module 30 can be configured to output a prompt to the user requesting a desired access level for the manager instance 28mi. Association module 30 can thus be configured to provide access rights based on a variety of different access levels.

In step 102, the association module 30 determines the region associated with the base instance 28bi. The region associated with the base instance 28bi can be referred to as a “resident location.” With the resident location identified, the association module 30 can identify the appropriate manager center 18 to provide services to resources 40 within the base instance 28bi. In the example shown, the location module 32 is configured to determine the resident location.

In some examples, the association module 30 is configured to determine the resident location based on identifying information of the base instance 28bi. The association module can determine the resident location of the base instance 28bi based on the resident location data extracted from the identifying information.

In some examples, identifying information can determined by association module 30 based on configuration data of the base instance 28bi. The configuration data can be provided to and stored within the base instance 28bi at initial setup of the base instance 28bi, such as on creation of base instance 28bi. For example, the configuration information can include resident location data, among other data (e.g., billing information, owner identity, etc.). With the resident location identified by association module 30, method 100 can move to step 104.

In some examples, the association module 30 can confirm the accuracy of the resident location as determined by the location module 32 prior to proceeding to step 104. In such an example, the resident location initially determined by the location module 32 can be referred to as a “determined location.” The association module 30 can confirm the accuracy of the determined location with regard to the actual resident location associated with the owner of the base instance 28bi.

In some examples, the association module 30 can cause owner system 14 to output the determined location to a user, such as via user interface 24. For example, the association module 30 can cause the user interface 24 to output a location confirmation prompt. The location confirmation prompt can ask the user to confirm the accuracy of the determined location relative to the actual resident location associated with the base instance 28bi. For example, the location confirmation prompt can be a visual prompt output via a display. The user can indicate that the determined location is accurate or inaccurate, such as via input to user interface 24.

If the determined location is confirmed as being the resident location (i.e., the determined location is indicated as accurate), method 100 moves to step 104. If the determined location is inaccurate, then the association module 30 can prompt the user to input a corrected location. For example, the association module 30 can generate and cause user interface 24 to output a location correction prompt. The location correction prompt can ask the user to input a resident location associated with the base instance 28bi. For example, the location correction prompt can be a visual prompt output via a display. The user can indicate the corrected location via input to user interface 24. The association module 30 can utilize the corrected location as the resident location and method 100 can move to step 104.

In some examples, the location module 32 may be unable to generate a determined location, such as when no locational information is available in the configuration data. In one such example, association module 30 can be configured to cause the user interface 24 to output a location identification prompt asking the user to input a user provided location. The association module 30 can receive the user provided location via the user interface 24 and treat the user provided location as forming the resident location. Method 100 can then move to step 104.

In some examples, the location module 32 is configured to identify only those locations that are associated with a manager center 18 of the servicer system 12 as possible locations for forming a resident location. For example, the configuration data of the base instance 28bi can indicate a resident location “A” while the servicer system 14 includes three manager centers 18 associated with locations “B.” “C.” and “D.” The location module 32 can be configured such that location “A” is not recognized as a possible resident location because there are no manager centers 18 associated with that location. In such an example, association module 30 can output a location identification prompt asking the user to input a user provided location. The association module 30 can receive the user provided location via the user interface 24 and treat the user provided location as forming the resident location. Method 100 can then move to step 104.

In step 104, the association module 30 identifies a manager center 18 configured to provide services the geographical region associated with the resident location. Such a manager center 18 can be referred to as “identified manager center.” In some examples, manager identity data for multiple manager centers 18 is recorded within identification module 34 of association module 30. The manager identity data can include a center location, which is the region associated with that manager center 18, and which center location can also be referred to as a “manager identity location”; can include instance information regarding the manager instance 28mi of IAM system 26 associated with that manager center 18 (e.g., identifying and access information for the manager instances 28); and can include other data for that manager center 18. The manager identity data can uniquely identify a manager instance 28mi of the IAM system 26.

The association module 30 can compare the resident location with center location information to identify a manager center 18 configured to provide services in the region associated with the base instance 28bi. For example, the association module 30 can compare the resident location, as determined in step 102, to a plurality of center locations stored in the identification module 34. The association module 30 can identify the center location that matches the resident location and identify the manager center 18 associated with that center location as the identified manager instance 28mi. The association module 30 can extract the manager identity data for the identified manager center 18 from the identification module 34 based on the comparison of the resident location and one or more center locations.

At step 106, the association module 30 edits access settings of the base instance 28bi to provide the identified manager center 18 access to resources 40 within the base instance 28bi. In the example shown, the access module 36 of the association module 30 is configured to edit one or more sets of access settings to provide access to the identified manager center 18. In some examples, the association module 30 edits the access settings based on a desired access level for the manager instance 28mi.

The association module 30 can be configured to edit the access settings at any desired hierarchical level. While described in more detail on a container-level, it is understood that not all examples are so limited. For example, association module 30 can be configured to edit access setting on a resource-level (e.g., individually by resource 40), on a hierarchical level intermediate containers 38 and resources 40 (e.g., to provide access to a group of, but less than all, resources 40 within a container 38); on a hierarchical level above containers 38 (e.g., to provide access to multiple containers 38 simultaneously); among other hierarchical access options.

The access module 36 can be configured to edit the access settings for one, two, three, or more, up to all, of the containers 38 within the base instance 28bi. In some examples, the association module 30 can be configured to concurrently modify a plurality of access settings for a plurality of containers 38 of the base instance 28bi, such that the manager instance 28mi is authorized to access each container 38 of the plurality of containers 38.

Editing the access settings for a container 38 can cause those access settings to cascade down the hierarchy (e.g., a hierarchy as shown in FIG. 2) such that the edited access settings apply to each resource 40 grouped within the container 38. The access module 36 can edit the access settings by providing the manager instance 28mi of the identified manager center 18 an access role within an RBAC system (e.g., a “manager” having full access to the container 38 without the ability to add/change users/roles). The identified manager center 18 is thereby provided with and authorized to access the container 38 and one more resources 40 grouped within that container 38.

In some examples, the association module 30 is configured to selectively edit access settings for the one or more containers 38. The association module 30 can identify one or more, up to all, of the containers 38 within base instance 28bi as candidate containers. The candidate containers are containers 38 identified by association module 30 as serviceable by the identified manager center 18. The access module 36 can be configured to edit the access settings of each of the candidate containers 38, in some examples. In other examples, the access module 36 is configured to cause the user interface 24 to output an access inquiry regarding the candidate containers.

The access inquiry can prompt the user to authorize or deny editing of the access settings for one or more of the candidate containers in response to the access inquiry. For example, the association module 30 can cause the user interface 24 to output a list of candidate containers. The user can then select, via user interface 24, one or more of the containers 38 from the list of candidate containers to authorize editing of the access rights for those selected containers 38. The access module 36 edits access rights for the candidate containers for which editing is authorized in response to the access inquiry. The access module 36 does not edit access rights for the candidate containers for which editing is not authorized in response to the access inquiry.

With the access settings of the one or more containers 38 modified, the identified manager center 18 is able to access the base instance 28bi. The identified manager center 18 can access the one or more containers 38 associated with the identified manager center 18 by the association module 30. The associated containers 38 can be accessed via the manager instance 28mi of the identified manager center 18. The identified manager center 18 is able to access the resources 40 grouped within the one or more associated containers 38. The identified manager center 18 can provide services to those resources 40 (e.g., infrastructure management, database management, security management, application management, etc.).

Association module 30 provides significant advantages. Association module 30 is configured to automatically identify the resident location of the base instance 28bi and to determine the manager instance 28mi that can service the resident location associated with the owner of the base instance 28bi. The association module 30 thereby eliminates user error and simplifies the process of associating an appropriate manager center 18 to service resources 40 within the base instance 28bi. The association module 30 can include manager identity data for each of the multiple manager centers 18 that are associated with various geographical regions. Such a configuration allows association module 30 to modify access settings for users across multiple regions, simplifying the process of providing access rights and freeing manpower and computing resources.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the present disclosure.

1. A method of associating users in a cloud computing space, the method comprising:
determining, by an association module executed by control circuitry of a computing device, a resident location associated with a base instance of an identity and access management system of the cloud computing space;
obtaining, by the association module, manager identity data from an identification module of the association module based on the resident location, the manager identity data uniquely identifying a manager instance of the identity and access management system;
editing, by the association module, access settings for a first container of the base instance such that the manager instance is authorized to access the first container and one or more resources grouped within the first container; and
accessing, by the manager instance, the first container of the base instance.

2. The method of claim 1, wherein determining, by the association module stored in the memory of the base computing device, the resident location associated with the base instance of the identity and access management system of the cloud computing space comprises:
identifying, by the association module, the resident location based on configuration information of the base instance.

3. The method of claim 2, further comprising:
causing, by the association module, a user interface to output a determined location associated with the base instance.

4. The method of claim 3, further comprising:
outputting, by the user interface, a location confirmation prompt; and
receiving, at the base computing device, an input in response to the location confirmation prompt, the input indicating a status of the determined location as one of accurately or inaccurately identifying the resident location.

5. The method of claim 4, further comprising:
utilizing the determined location as the resident location based on the status of the determined location being accurate.

6. The method of claim 4, further comprising:
utilizing a location other than the determined location as the resident location based on the status of the determined location being inaccurate.

7. The method of claim 6, further comprising:
receiving the location other than the determined location via the user interface.

8. The method of claim 1, wherein obtaining, by the association module, the manager identity data from the identification module of the association module based on the resident location comprises:
comparing, by the association module, the resident location to a plurality of manager identity locations stored in the identification module to identify one manager identity location of the plurality of manager identity locations that matches the resident location;
identifying, by the association module as the manager identity data, first identity data associated with the identified one manager identity location that matches the resident location.

9. The method of claim 1, wherein editing, by the association module, the access settings for the first container of the base instance comprises:
identifying, by the association module, a plurality of containers of the base instance as candidate containers, the plurality of containers including the first container; and
editing, by the association module, access settings of at least one of the candidate containers such that the manager instance of the identity and access management system is authorized to access the at least one of the candidate containers, the first container forming the at least one of the candidate containers.

10. The method of claim 9, further comprising:
outputting, by a user interface, an access inquiry regarding the candidate containers; and
editing the access settings of the at least one of the candidate containers based on an affirmative response to the access inquiry.

11. The method of claim 1, wherein editing, by the association module, the access settings for the first container of the base instance comprises:
identifying, by the association module, a plurality of containers of the base instance as candidate containers, the plurality of containers including the first container; and
editing, by the association module, access settings of each of the candidate containers such that the manager instance of the identity and access management system is authorized to access each of the candidate containers.

12. The method of claim 1, further comprising:
receiving, by the computing device, the association module from a remote computing device.

13. The method of claim 1, further comprising:
accessing, by the computing device, the base instance prior to executing the association module by the control circuitry.

14. The method of claim 1, wherein editing, by the association module, access settings for a first container of the base instance comprises:
concurrently modifying a plurality of access settings for a plurality of containers of the base instance, such that the manager instance is authorized to access each container of the plurality of containers, the plurality of containers including the first container.

15. A system for associating users in a cloud computing space, the system comprising:
a computing device having a memory and control circuitry configured to execute instructions stored in the memory;
a remote computing device configured to transmit an association module to the computing device;
wherein the control circuity is configured to execute the association module to cause the association module to:
determine a resident location associated with a base instance of an identity and access management system of the cloud computing space;
obtain manager identity data from an identification module of the association module based on the resident location, the manager identity data identifying a manager instance of the identity and access management system; and
edit access settings for a first container of the base instance, such that the manager instance is authorized to access the first container and one or more resources grouped within the first container.

16. The system of claim 15, wherein the association module is further configured to:
determine resident location information based on configuration information of the base instance.

17. The system of claim 15, wherein the control circuity is configured to execute the association module while accessing the base instance.

18. The system of claim 15, wherein:
the computing device is configured to output a determined location for the base instance based on determined location information generated by the association module;
the computing device is configured to receive an input indicating a status of the determined location; and
the association module is configured to either treat the determined location as the resident location based on a status of the determined location as accurate or treat a location other than the determined location as the resident location based on a status of the determined location as inaccurate.

19. The system of claim 15, wherein the association module is configured to obtain the manager identity data from the identification module of the association module based on the resident location by:
comparing the resident location to a plurality of manager identity locations stored in the identification module to identify a first location of the plurality of manager identity locations as a location match with the resident location; and
designating identity data associated with the first location of the plurality of manager identity locations as the manager identity data.

20. A method of associating users in a cloud computing space, the method comprising:
determining, by an association module executed by control circuitry of a computing device, a resident location associated with a base instance of an identity and access management system of the cloud computing space;
comparing, by the association module, the resident location to a plurality of manager identity locations stored in an identification module of the association module to identify a manager identity location of the plurality of manager identity locations as a location match with the resident location;
obtaining, by the association module, manager identity data associated with the manager identity location of the plurality of manager identity locations, the manager identity data uniquely identifying a manager instance of the identity and access management system;
identifying, by the association module, a candidate container from within the base instance;
editing, by the association module, access settings of the candidate container such that the manager instance is authorized to access the candidate container; and one or more resources grouped within the candidate container; and
accessing, via the manager instance, the candidate container.
